(19) United States
(12) Patent Application Publication
(10) Pub. No.: US 2013/0101725 A1
(43) Pub. Date: Apr. 25, 2013

(54) PROCESS FOR THE MANUFACTURE OF INFUSIBLE BEVERAGE PRODUCTS

(71) Applicants: Jonathan George Collett, Sharnbrook (GB); Andrew Paul Ormerod, Sharnbrook (GB)

(72) Inventors: Jonathan George Collett, Sharnbrook (GB); Andrew Paul Ormerod, Sharnbrook (GB)

(21) Appl. No.: 13/704,993

(22) PCT Filed: Jun. 29, 2011
(86) PCT No.: PCT/EP11/60958

§ 371 Date: Dec. 18, 2012

(30) Foreign Application Priority Data
Jul. 2, 2010 (EP) 10168329.0

(51) Int. Cl. A23F 3/14

(52) U.S. Cl. CPC A23F 3/14
USPC 426/597; 426/590; 426/394

(57) ABSTRACT

A process for the manufacture of an infusible beverage product comprising hygroscopic fruit pieces the process comprising the steps of: a) providing plant material particles less than 1.5 mm in diameter and fruit pieces; b) admixing the plant material particles and fruit pieces; and then c) combining the plant material particles and fruit pieces with additional infusible beverage product ingredients is provided. An infusible beverage product comprising hygroscopic fruit pieces and plant material particles characterised in that the fruit pieces are less than 8 mm in diameter and the plant material particles are less than 1.5 mm in diameter is also provided.

### TECHNICAL FIELD

The present invention relates to infusible beverage products containing fruit pieces. More particularly, this invention relates to infusible beverage products with fruit pieces that do not suffer from aggregation during manufacture or storage.

### BACKGROUND TO INVENTION

With the exception of water, infusible beverage products such as tea are the most widely consumed of all beverages. There are many different variants of infusible beverage products that can be used to make beverages and one group of such variants is fruit infusions which are becoming increasingly popular world-wide. Fruit infusions are typically based on a standard infusible beverage product such as leaf tea but with added fruit flavourings and aromas. These infusible beverage products are able to deliver products with all the typical benefits of beverages such as tea but with the additional benefit of fruit flavour and aroma. Infusible beverage products are now available that even contain real fruit pieces, for example Lipton Tea Forest Fruit consists of flavoured black tea to which pieces of dehydrated strawberry, redcurrant, raspberry and blackberry are added. These products containing real fruit pieces are especially enjoyed by consumers due to the healthy connotations of the fruit, the appealing taste and aroma, and the exciting consumer experience and visual cues that are provided by the fruit pieces. In particular, the fruit pieces are clearly observable in the product prior to use and can be seen to circulate within the beverage during brewing.

Typical infusible beverage products are manufactured on standard production lines in the following way. The infusible beverage ingredients are dosed into the production line using a dosing wheel which has indentations on the circumference of the wheel that measure out the correct quantity (i.e. volume) of the ingredients needed. As the dosing wheel turns, the ingredients fall out onto any packaging material that may be used, which may be, for example, a tea bag or a larger packet for loose leaf products. In other production lines the ingredients measured out by the dosing wheel are actually conveyed to another part of the apparatus for packaging. This conveyance can be done using belts and hoppers but may also be achieved pneumatically by forcing the product through tubes using air pressure or vacuum systems. The manufacturing process for infusible beverage products containing fruit pieces is very similar to the process described above with the exception that the fruit pieces are also dosed into the dosing wheel with the infusible beverage ingredients before being conveyed to the packaging apparatus. However, the manufacturing process for infusible beverage products containing fruit pieces is negatively affected because of the adherent properties of the fruit pieces. The fruit pieces used in infusible beverage products are typically dried or dehydrated but as they absorb moisture from the atmosphere they may become sticky and aggregate into solid masses before, during and after production. This prevents the production line from operating and ultimately results in an inferior product. In addition, the fruit pieces also cause the dosing wheel itself to become sticky and ingredients are not dosed correctly. Furthermore, as the fruit pieces move though the production lines they cause the rest of the apparatus to become sticky also causing production to slow and even stop in order to clean the machinery. In some instances aggregation can even lead to machine breakdown.

Certain approaches for minimising stickiness in foods are outlined in B. Adhikari et al. (2001) “stickiness in foods: a review of mechanisms and test methods” Int J Food Prop 4: 1-33. For example, the addition of food-grade anticaking agents such as silicon dioxide are said to improve the flowability of food powders. However, consumers increasingly perceive such additives as being artificial and hence undesirable.

Thus, there is a need for infusible beverage products containing fruit pieces that retain all the consumer-acceptable characteristics of such products but that do not suffer from the problem of aggregation.

### BRIEF DESCRIPTION OF THE INVENTION

We have now found that by employing plant material particles of a specific size it is possible to produce infusible beverage products containing fruit pieces that do not suffer from aggregation yet that have excellent palatability and consumer-acceptable characteristics. Furthermore, such plant material particles are entirely natural ingredients that are acceptable to the consumer. Additionally such plant material particles can be incorporated into the product easily and without the need for alteration of the production lines currently used.

Accordingly, in a first aspect, the present invention provides a process for the manufacture of an infusible beverage product comprising hygroscopic fruit pieces the process comprising the steps of:
a) providing plant material particles less than 1.5 mm in diameter and dried fruit pieces;
b) admixing the plant material particles and fruit pieces; and then
c) combining the plant material particles and fruit pieces with additional infusible beverage product ingredients.

In a second aspect the present invention provides an infusible beverage product comprising hygroscopic fruit pieces, plant material particles and infusible beverage product ingredients, characterised in that the fruit pieces are less than 8 mm in diameter, the plant material particles are less than 1.5 mm in diameter and the beverage product ingredients have a diameter of 1.5 mm or greater.

In a third aspect the present invention provides a method of preventing aggregation of hygroscopic fruit pieces comprising the steps of:
a) providing the fruit pieces; and
b) admixing plant material particles with the fruit pieces; wherein the fruit pieces are less than 8 mm in diameter and the plant material particles are less than 1.5 mm in diameter.

In a fourth aspect the present invention provides a use of plant material particles to prevent aggregation of hygroscopic fruit pieces wherein the fruit pieces are less than 8 mm in diameter and the plant material particles are less than 1.5 mm in diameter.

In a final aspect the present invention provides an infusible beverage product obtained or obtainable from the process of the first aspect.

### BRIEF DESCRIPTION OF THE DRAWINGS

FIG. 1 shows the prevention of aggregation of pineapple fruit pieces in the presence of tea dust.

FIG. 2 shows the prevention of aggregation of pineapple fruit pieces in the presence of small leaf tea.

FIG. 3 shows the prevention of aggregation of strawberry fruit pieces in the presence of tea dust.

FIG. 4 shows the prevention of aggregation of strawberry fruit pieces in the presence of small leaf tea.

### DETAILED DESCRIPTION OF THE INVENTION

Unless defined otherwise, all technical and scientific terms used herein have the same meaning as commonly understood by one of ordinary skill in the art (e.g. in infusible beverage manufacture).

Adherent Fruit Pieces

The present invention is directed towards infusible beverage products containing fruit pieces that do not suffer from aggregation. As discussed above, fruit pieces have adherent properties that cause aggregation and also cause the processing apparatus to become sticky and to malfunction. Without wishing to be bound by theory, the adherent nature of fruit pieces is thought to be due in part to the sugars in the fruit which, when the fruit contains water, become partially solubilised and form an adherent layer on the surface of the fruit pieces. Fruit pieces used in infusible beverage product are typically dried or dehydrated. For example, fruit pieces can be subjected to freeze drying wherein they are frozen, the surrounding pressure is reduced, and a corresponding increase in temperature causes the frozen water in the fruit pieces to sublime directly from the solid phase to the gas phase. Both drying and dehydration cause the fruit pieces to lose their water content but as a consequence dried fruit pieces are hygroscopic, meaning that they are able to attract water molecules from the surrounding environment. This attraction can be through either absorption or adsorption. As a result, whenever dried fruit pieces are exposed to an atmosphere with any humidity they absorb water, become adherent, and aggregation occurs.

It has now been found that it is possible to prevent aggregation through the use of plant material particles of a specific size. Without wishing to be bound by theory, it is believed that when the fruit pieces are brought into contact with the plant material particles the particles adhere to the surface of the fruit pieces and create a barrier thus preventing aggregation between the fruit pieces and also preventing the fruit pieces from transferring their adherent layer to any other objects such as the processing apparatus. In order to ensure that the plant material particles are able to function in this way it has been found that they must be less than 1.5 mm in diameter, preferably less than 1 mm in diameter, more preferably less than 0.75 mm, more preferably still less than 0.5 mm, yet more preferably still less than 0.4 mm, most preferably less than 0.25 mm. Preferably the plant material particles are at least 0.01 mm in diameter, more preferably at least 0.025 mm, more preferably still at least 0.05 mm.

The first aspect of this invention provides a process for the manufacture of an infusible beverage product containing fruit pieces that makes use of such plant material particles. The fruit pieces are typically dried because in this form they are easier to process than non-dehydrated fruit pieces and are preserved for long periods of storage. Dried fruit pieces have a moisture content of less than 30%, preferably the moisture content is from 0.1 to 10%. As such, the fruit pieces are hydroscopic so they attract water and thus become adherent (e.g. via the formation of an adherent layer as described above). It is therefore not uncommon to find that the fruit pieces have already aggregated prior to use, for example some containers of dried fruit pieces when opened in the factory are found to have aggregated into a solid block and must therefore be broken up and fully separated prior to use. In the process according to the invention fruit pieces are admixed with plant material particles to ensure that the fruit pieces are separated and that their surfaces are exposed to the particles.

This separation and admixing can be performed using techniques and equipment known to the person skilled in the art, for example rotating mixing barrels or vibrating tables may be employed. Once the fruit pieces and plant material particles have been admixed any excess plant material particles are optionally removed. In a preferred embodiment, the optional removal of excess plant material particles is achieved by sieving using a sieve with an appropriate mesh size (i.e. a mesh size selected such that fruit pieces will be retained by the sieve while any excess plant material particles will pass through the sieve).

Following the admixing of the fruit pieces and the plant material particles additional infusible beverage product ingredients as described below are then added.

Plant Material Particles

The plant material particles may comprise any part of the plant but are preferably from the leaf, stem and/or flower. Preferably the plant material particles have been dried to a water content of less than 30% by weight, more preferably to a water content of 0.1 to 10% by weight. The plant material particles are not necessarily tea plant material particles but in a particularly preferred embodiment they are. In other preferred embodiments the plant material particles may comprise plant material that is usually regarded to be a waste product, such as the skin and/or shell of peanuts. Preferably the infusible beverage product comprises plant material particles in an amount of at least 0.05 wt % of the product, more preferably at least 0.1 wt %, more preferably still at least 0.2 wt %, yet more preferably still at least 0.5 wt %. Preferably the infusible beverage product comprises plant material particles in an amount of at most 5 wt % of the product, more preferably at most 2 wt %, more preferably still at most 1 wt %.

Diameter

The plant material particles may have heterogeneous shapes, sizes, volumes, surface areas and so on. Particles may be circular, non-circular or a mixture thereof. In some preferred embodiments, the particles are substantially flat. As used herein, the term diameter refers to the maximum length of the plant material particles in any dimension. For particles having an irregular shape, the diameter is the length of the longest cross section that can be cut through the body of the particle. When the diameter of plant material particles or the diameter of fruit pieces is referred to it is meant that at least 90% by number of the particles or pieces have that diameter, more preferably from 90 to 100% by number.

Type of Plant Material

The plant material particles can be from any plant suitable for human consumption. The plant material particles preferably comprise insoluble plant material, i.e. plant material that is substantially insoluble in an aqueous liquid. In a particularly preferred embodiment the plant material particles comprise plant material that is insoluble in water. Nevertheless, it should be noted that it will usually be possible to extract certain water-soluble substances from the plant material particles. Tea plant material, especially tea leaves, is particularly suitable for this invention and so in a preferred embodiment the plant material particles are tea. “Tea” for the purposes of the present invention means material from Camellia sinensis var. sinensis and/or Camellia sinensis var. assamica. In another preferred embodiment the plant material particles may be herb plant material, or a mixture of tea plant material and herb plant material.

Fruit Pieces

Any fruit that is suitable for human consumption can be used in infusible beverage products for example fruits selected from the group comprising acerola, apple, apricot, bilberry, blackberry, blueberry, cherry, citron, clementine, cloudberry, cranberry, date, dragonfruit, elderberry, fig, gooseberry, granadilla, grape, grapefruit, greengage, guava, kiwi fruit, kumquat, lemon, lime, loganberry, lychee, mandarin, mango, medlar, melon, mulberry, orange, papaya, passion fruit, paw paw, peach, pear, physalis, pineapple, plum, pomegranate, quince, raspberry, strawberry, tangerine, watermelon, or mixtures thereof can be used.

The fruit pieces may be real fruit pieces or reformed fruit granules, with real fruit pieces being particularly preferred. In both instances the fruit pieces are substantially insoluble in an aqueous liquid such as water (i.e. the fruit pieces will not dissolve when steeped or soaked in an aqueous liquid, although they will typically release certain water-soluble substances into the liquid, e.g. flavour and/or aroma molecules).

It has been found that smaller fruit pieces are particularly prone to aggregation and so the fruit pieces are preferably less than 8 mm in diameter, more preferably less than 4 mm, more preferably still less than 2 mm, most preferably less than 1 mm. In order for the fruit pieces to be noticeable to the consumer they are preferably more than 0.1 mm in diameter, more preferably more than 0.2 mm, more preferably still more than 0.3 mm. Preferably the infusible beverage product comprises fruit pieces in an amount of at least 0.05 wt % of the product, more preferably at least 0.1 wt %, more preferably still at least 0.2 wt %, yet more preferably at least 0.5 wt %. In certain embodiments the infusible beverage product may comprise fruit pieces in an amount of up to 99.95 wt % of the product. Preferably the infusible beverage product comprises fruit pieces in an amount of at most 20 wt % of the product, more preferably at most 10 wt %, more preferably still at most 5 wt %, yet more preferably still at most 2 wt %, most preferably at most 1 wt %.

Ratio of Plant Material Particles to Fruit Pieces

In order to ensure that the fruit pieces can be adequately coated with plant material particles the weight ratio of plant material particles to fruit pieces in the infusible beverage product is preferably at most 20:1, more preferably at most 10:1, more preferably still at most 5:1. Preferably the weight ratio of plant material particles to fruit pieces in the infusible beverage product at least 1:20, more preferably at least 1:10, more preferably still at least 1:5.

Infusible Beverage Product

As used herein the term infusible beverage product refers to products containing infusible ingredients that when steeped or soaked in an aqueous liquid release certain soluble substances into the liquid thereby to form a beverage. This process is referred to as brewing which is the addition of a liquid to an infusible ingredient thereby to form a beverage. Brewing may be carried out at any temperature but is preferably carried out at least 40° C., more preferably at least 55° C., more preferably still at least 70° C. and preferably less than 120° C., more preferably less than 100° C., more preferably still less than 90° C., most preferably less than 80° C. Beverage refers to a substantially aqueous drinkable composition suitable for human consumption. Preferably beverages comprise at least 85% water by weight of the beverage, more preferably at least 90% and most preferably from 95 to 99.9%.

Additional Infusible Beverage Product Ingredients

As described above, once the fruit pieces and plant material particles have been admixed and the excess plant material particles have been optionally removed the remaining infusible beverage product ingredients are added. These remaining ingredients include the infusible ingredient of the infusible beverage product, i.e. the ingredient(s) that when steeped or soaked in an aqueous liquid release certain soluble substances into the liquid thereby to form a beverage. In a preferred embodiment the infusible ingredient is tea. Tea for the purposes of the present invention means material from the leaves and/or stem of Camellia sinensis var. sinensis and/or Camellia sinensis var. assamica. Preferably at least 90% by number of the infusible beverage product ingredients have a diameter of 1.5 mm or greater. The term “tea solids” refers to dry material extractable from the leaves of the plant Camellia sinensis var. sinensis and/or Camellia sinensis var. assamica. The material may have been subjected to a so-called “fermentation” step wherein it is oxidised by certain endogenous enzymes that are released during the early stages of “black tea” manufacture. This oxidation may even be supplemented by the action of exogenous enzymes such as oxidases, laccases and peroxidases. Alternatively the material may have been partially fermented (“oolong” tea) or substantially unfermented (“green tea”). A tea-based beverage is therefore a beverage comprising at least 0.01% by weight tea solids. Preferably a tea-based beverage comprises from 0.04 to 3%, more preferably from 0.06 to 2%, most preferably from 0.1 to 1% by weight tea solids.

In another embodiment the infusible ingredients may be herbs which may be selected from the group consisting of angelica (angelica archangelica), anise (pimpinella anisum), bergamot (monarda didyma), borage (borago officinalis), calendula (calendula officinalis), camphor laurel (cinnamomum camphora), chervil (anthriscus cerefolium), chicory (cichorium intybus), cilantro (coriandrum sativum), cumin (cuminum cyminum), dill (anethum graveolens), elderflower (sambucus spp.), fennel (foeniculum vulgare), fenugreek (trigonella foenum-graecum), ginger (zingiber officinale), hibiscus (hibiscus spp.), hops (humulus lupulus), hyssop (hyssopus officinalis), jasmine (jasminum spp.), lavender (lavandula spp.), lemongrass (cymbopogon citratus), liquorice, licorice (glycyrrhiza glabra), lovage (levisticum officinale), marjoram (origanum majorana), mint, nasturtium (tropaeolum majus), peppermint (mentha piperata), rooibos (aspalathus linearis), rosehip (rosa spp.), rosemary (rosmarinus officinalis), sorrel (rumex acetosa), spearmint (mentha spicata), thyme (thymus vulgaris), tumeric (curcuma longa), or a mixture thereof. In a further embodiment, the infusible ingredients may also be a mixture of tea and one or more of the abovementioned herbs.

The infusible ingredient may also be any other suitable ingredient known to the person skilled in the art.

Preferably the infusible beverage ingredients have been dried to a water content of less than 30% by weight, more preferably the water content is in the range of 0.1 to 10% by weight.

Other ingredients may also be added to form the final infusible beverage product, including sweeteners, sugars, flavourings, colourants and aromas.

Porous Container

When all the ingredients of the infusible beverage product have been combined together they may then be packaged, preferably in a porous container. The process may therefore optionally provide a step wherein the infusible beverage product is packaged into suitable containers such as tea bags, cartridges for beverage brewing machines, tea sticks and the like.

In the second aspect the invention provides an infusible beverage product comprising hygroscopic fruit pieces, plant material particles and infusible beverage product ingredients. As described above, the fruit pieces are less than 8 mm in diameter, the plant material particles are less than 1.5 mm in diameter and the infusible beverage product ingredients have a diameter of 1.5 mm or greater. The product therefore benefits from the action of the plant material particles which adhere to the surface of the hygroscopic fruit pieces when they absorb moisture and in this way the product does not suffer from aggregation of the fruit pieces during storage. To provide optimal adherence, preferably the plant material particles are less than 1 mm in diameter, more preferably less than 0.75 mm, more preferably still less than 0.5 mm, yet more preferably still less than 0.4 mm, most preferably less than 0.25 mm. Preferably the plant material particles are at least 0.01 mm in diameter, more preferably at least 0.025 mm, more preferably still at least 0.05 mm. Preferably the infusible beverage product comprises plant material particles in an amount of at least 0.05 wt % of the product, more preferably at least 0.1 wt %, more preferably still at least 0.2 wt %, yet more preferably still at least 0.5 wt %. Preferably the infusible beverage product comprises fruit pieces in an amount of at most 20 wt % of the product, more preferably at most 10 wt %, more preferably still at most 5 wt %, yet more preferably still at most 2 wt %, most preferably at most 1 wt %.

The fruit pieces are preferably less than 8 mm, more preferably less than 4 mm, most preferably less than 2 mm in diameter. In order for the fruit pieces to be noticeable to the consumer they are preferably more than 0.1 mm in diameter, more preferably more than 0.2 mm, more preferably still more than 0.3 mm. Preferably the infusible beverage product comprises fruit pieces in an amount of at least 0.05 wt % of the product, more preferably at least 0.1 wt %, more preferably still at least 0.2 wt %, yet more preferably at least 0.5 wt %. Preferably the infusible beverage product comprises fruit pieces in an amount of at most 5 wt % of the product, more preferably at most 2 wt %, more preferably still at most 1 wt %.

This work has identified that plant material particles less than 1.5 mm in diameter are surprisingly suitable for preventing hydroscopic fruit pieces from clumping together. The third aspect the invention therefore provides a method of preventing aggregation of hygroscopic fruit pieces comprising the steps of:
a) providing the fruit pieces; and
b) admixing plant material particles with the fruit pieces; wherein the fruit pieces are less than 8 mm in diameter and the plant material particles are less than 1.5 mm in diameter.

In the fourth aspect, the invention provides a use of plant material particles less than 1.5 mm in diameter to prevent aggregation of hygroscopic fruit pieces less than 8 mm in diameter.

### Examples

The present invention will now be further described with reference to the following examples, which are illustrative only and non-limiting.

In order to assess the ability of the plant material particles to prevent aggregation of fruit pieces the following experiments were preformed. These experiments were carried out in a controlled environment at 75% humidity which is representative of the conditions that may arise in packaging factories at which fruit pieces take up water from the atmosphere and suffer from aggregation as described above.

Fruit Pieces

Freeze-dried pineapple and freeze-dried strawberry fruit pieces fruit pieces were obtained from Dr. Suwelack, Germany. The fruit pieces were separated using sieving methods known to the person skilled in the art to grade the fruit pieces into three size ranges: 1-2 mm; 2-4 mm; and 4-6 mm.

Plant Material Particles

The plant material particles used in these experiments were particles of standard black tea (Kenyan Kericho Tea). The plant material particles were graded using sieving methods known to the person skilled in the art to grade the plant material particles into two size ranges: “Tea dust” which had particles smaller than 0.5 mm in diameter; and “Small leaf tea” which had larger particles from 0.5 mm up to 1.5 mm in diameter.

### Comparative Examples

For the comparative examples, approximately 1 g of each size range (1-2 mm; 2-4 mm; and 4-6 mm) of the dried fruit pieces (pineapple or strawberry) were placed into separate screw-top tubes which were 7 cm in height and 2.5 cm in diameter. These control tubes with fruit pieces only were left in an upright position and open to the atmosphere for 24 hrs. After 24 hours the tubes were sealed with the screw top and the aggregation of the fruit pieces was assessed as described below. These tubes were then left for a further 4 days after which the aggregation of the fruit pieces was assessed again.

### Samples According to the Invention

In the process according to the invention approximately 1 g of each size range (1-2 mm; 2-4 mm; and 4-6 mm) of the dried fruit pieces (pineapple or strawberry) were placed into the same type of screw-top tubes. Approximately 1.75 g of the smaller plant material particles (Tea dust) were then added to the dried fruit pieces in one set of tubes. To the dried fruit pieces in another set of tubes was added approximately 1.75 g of the larger plant material particles (Small leaf tea). The fruit pieces were mixed with the plant material particles by gently rotating the tubes to evenly distribute the contents. These tubes with fruit pieces and plant material particles were also left in an upright position and open to the atmosphere for 24 hrs. After 24 hours excess plant material particles were removed by sieving. The two sets of tubes (with Tea dust or Small leaf tea) were sealed with the screw top and aggregation of fruit pieces was assessed as described below. These tubes were left for a further 4 days after which the aggregation of fruit pieces was assessed again.

Assessment of Aggregation of Fruit Pieces Each of the tubes containing the comparative samples and the samples according to the invention were manually tapped gently against a wooden bench and placed on their sides. Aggregation was qualitatively assessed by observing the behaviour of the fruits pieces within the tubes. Aggregated fruit pieces were easily identifiable because of the clumped formation of the fruit pieces within the tubes. Some samples displayed such extreme aggregation that the fruit pieces remained in exactly the same position as when the tube was upright—i.e. clumped in a solid mass at the base of the tube. Other aggregated fruit pieces fell away from the sides of the tube but remained in a clearly identifiable clump. Conversely, fruit pieces which had not suffered aggregation could be easily observed because following the gentle tapping they readily formed a free-flowing, clump free conformation and were observed to be evenly spread along the bottom of the tubes.

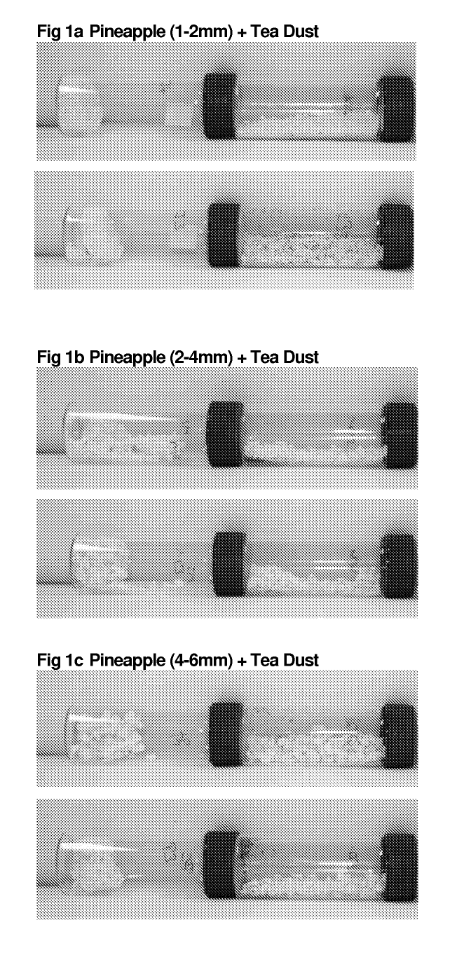

Photographs of all samples were taken and the results are described below. In all figures (i.e. FIGS. 1a, 1b, 1c, 2a, 2b, 2c, 3a, 3b, 3c, 4a, 4b, and 4c) the control sample is shown in the left tube and samples according to the invention is shown in the right tube. In each of FIGS. 1a to 4c, the upper images show the samples after 24 hours and the lower images show the samples after the further 4 days. In all figures the first figure (i.e. FIGS. 1a, 2a, 3a, 4a) shows fruit pieces of 1-2 mm, the second (i.e. FIGS. 1b, 2b, 3b, 4b) shows fruit pieces of 2-4 mm, and the third (i.e. FIGS. 1c, 2c, 3c, 4c) shows fruit pieces of 4-6 mm.

### Results

### Experiment 1

### Pineapple Fruit Pieces with Smaller Plant Material Particles

In the left hand tubes of the photographs of FIG. 1 it can clearly be seen that all size ranges of fruit pieces suffered from aggregation after both 24 hours and after 4 days with the pineapple pieces clearly remaining in a solid mass at base of the tube. In contrast, the presence of the tea dust resulted in fruit pieces that did not suffer from aggregation and that were clearly evenly spread across the bottom of the tube. Upon manipulation of the tube these fruit pieces were observed to be free flowing.

### Experiment 2

### Pineapple Fruit Pieces with Larder Plant Material Particles

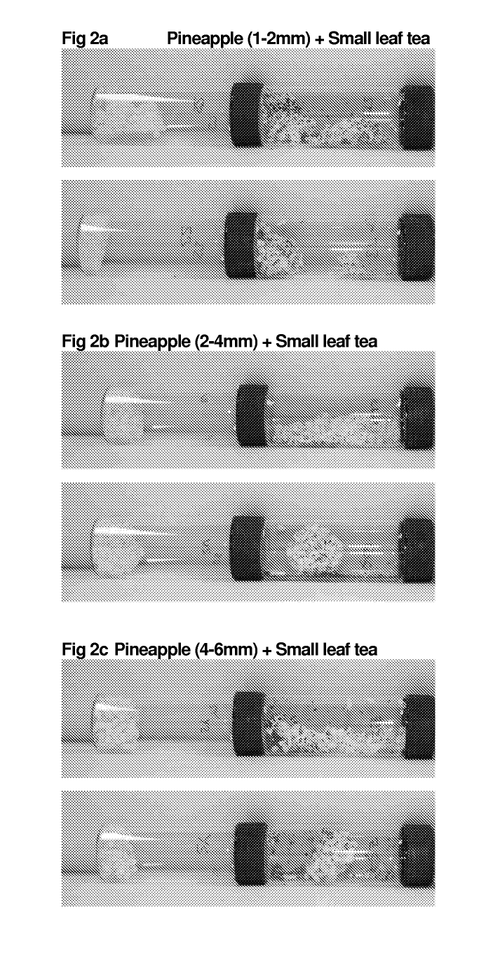

Again, in the left hand tubes of the photographs of FIG. 2 it can clearly be seen that in the absence of plant material particles all size ranges of fruit pieces suffered from aggregation after both 24 hours and after 4 days with the pineapple pieces clearly remaining in a solid mass at base of the tube. The small leaf tea did not create such clearly free flowing fruit pieces as with the tea dust of experiment 1 but it was observed that after gentle agitation of the tubes containing fruit pieces plus small leaf tea the clumps that were seen in the right hand tubes of FIG. 2 fell apart to form unaggregated pieces. This additional gentle agitation will be readily experienced in the pre-processing steps of the manufacture of products comprising fruit pieces plus small leaf tea and is therefore this level of prevention of aggregation is perfectly acceptable.

### Experiment 3

### Strawberry Fruit Pieces with Smaller Plant Material Particles

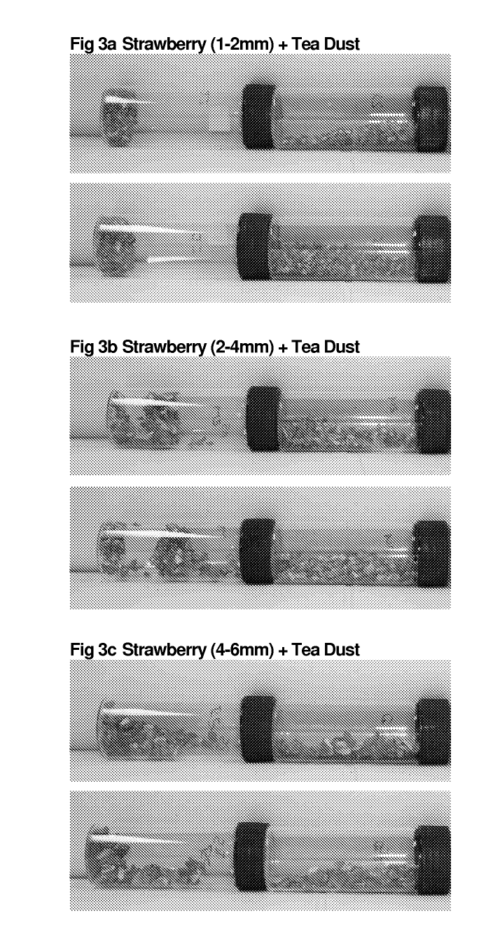

As with the pineapple fruit pieces, the strawberry fruit pieces in the left hand tubes of the photographs of FIG. 3 were seen to have aggregated and were clumped in the base of the tube. The clumping of the 4-6 mm strawberry pieces in the left hand tubes of FIG. 3c was not as marked as with the experiments 1 and 2. It is believed that this is a result of the different packing properties of the large strawberry fruit pieces. Nevertheless, it was readily observed that in the presence of the tea dust (right hand tubes) the fruit pieces were evenly spread across the bottom of the tube and had not suffered from aggregation. Upon manipulation of the tube these fruit pieces were also observed to be free flowing.

### Experiment 4

### Strawberry Fruit Pieces with Larger Plant Material Particles

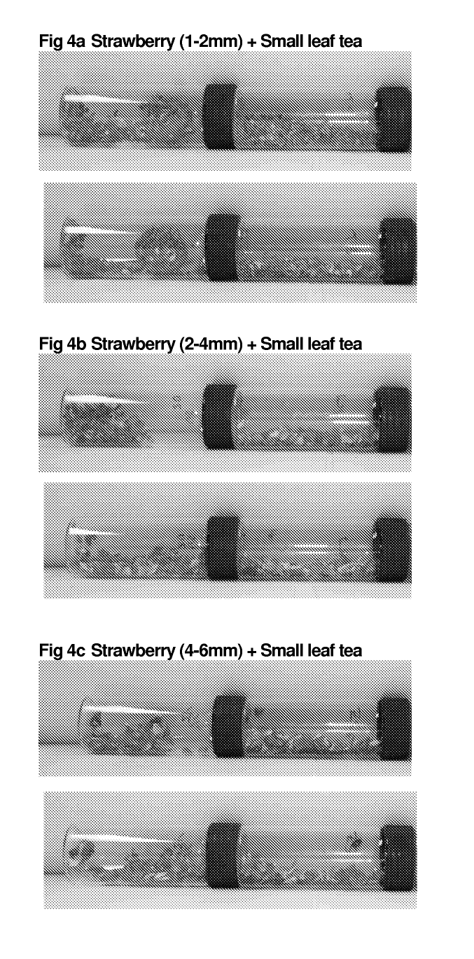

As with the experiment 3, the strawberry fruit pieces in the left hand tubes of the photographs of FIG. 4 were seen to have aggregated and had formed distinct clumps but again, the clumping of the 4-6 mm strawberry pieces in the left hand tubes of FIG. 4c was not as marked as with the experiments 1 and 2 (again, a result of the different packing properties of the large fruit pieces). However, it was still seen that in the presence of the small leaf tea (right hand tubes) the fruit pieces were evenly spread across the bottom of the tube and had not suffered from aggregation at all.

The results from these experiments demonstrate that the aggregation of fruit pieces is a serious concern and show that clumping can occur easily and cannot be reversed even through agitation. The results further show that the use of plant material particles according to this invention can be employed in order to prevent aggregation of fruit pieces even in very humid conditions and even after very long periods of storage of the fruit pieces under these conditions.

1. A process for the manufacture of an infusible beverage product comprising hygroscopic fruit pieces the process comprising the steps of:
a. providing plant material particles less than 1.5 mm in diameter and dried fruit pieces;
b. admixing the plant material particles and fruit pieces; and then
c. combining the plant material particles and fruit pieces with additional infusible beverage product ingredients.

2. A process according to claim 1 wherein steps a) and b) are performed prior to any subsequent processing steps.

3. A process according to claim 1 or claim 2 wherein the plant material particles are less than 1 mm in diameter, more preferably less than 0.75 mm, more preferably still less than 0.5 mm, yet more preferably still less than 0.4 mm, most preferably less than 0.25 mm.

4. A process according to any of the preceding claims wherein the infusible beverage product comprises the plant material particles an amount of from 0.05 to 5 wt % of the product.

5. A process according to any of the preceding claims wherein the weight ratio of plant material particles to fruit pieces in the infusible beverage product is from 20:1 to 1:20.

6. A process according to any of the preceding claims wherein the plant material particles are particles of tea.

7. A process according to any of the preceding claims wherein the process comprises an additional step wherein the infusible beverage product is packaged.

8. An infusible beverage product obtainable from the process of any of claims 1 to 7.

9. An infusible beverage product comprising hygroscopic fruit pieces, plant material particles and infusible beverage product ingredients, characterised in that the fruit pieces are less than 8 mm in diameter, the plant material particles are less than 1.5 mm in diameter and the beverage product ingredients have a diameter of 1.5 mm or greater.

10. An infusible beverage product according to claim 9 wherein the plant material particles are less than 1 mm in diameter, more preferably less than 0.75 mm, more preferably still less than 0.5 mm, yet more preferably still less than 0.4 mm, most preferably less than 0.25 mm.

11. An infusible beverage product according to claim 9 or claim 10 wherein the product comprises the plant material particles in an amount of from 0.05 to 5 wt % of the product.

12. An infusible beverage product according to any of claims 9 to 11 wherein the plant material particles are particles of tea.

13. An infusible beverage product according to any of claims 9 to 12 wherein the weight ratio of plant material particles to fruit pieces in the infusible beverage product is from 20:1 to 1:20.

14. A method of preventing aggregation of hygroscopic fruit pieces comprising the steps of:
a. providing the fruit pieces; and
b. admixing plant material particles with the fruit pieces;
wherein the fruit pieces are less than 8 mm in diameter and the plant material particles are less than 1.5 mm in diameter.

15. A use of plant material particles to prevent aggregation of hygroscopic fruit pieces wherein the fruit pieces are less than 8 mm in diameter and the plant material particles are less than 1.5 mm in diameter.
